(19) United States
(12) Patent Application Publication
(10) Pub. No.: US 2026/0139648 A1
(43) Pub. Date: May 21, 2026

(54) FUEL COOLER

(71) Applicant: ISUZU MOTORS LIMITED, Yokohama-shi (JP)

(72) Inventors: Daisuke NAKANO, Fujisawa-shi (JP); Shinichi ISHIBASHI, Fujisawa-shi (JP)

(21) Appl. No.: 19/365,598

(22) Filed: Oct. 22, 2025

(30) Foreign Application Priority Data
Nov. 15, 2024 (JP) 2024-199534

(51) Int. Cl. F02M 31/20

(52) U.S. Cl. CPC F02M 31/20

(57) ABSTRACT

A fuel cooler of the present disclosure includes a cooler body and a cooler cover that is provided to surround the cooler body. The fuel cooler is disposed, as viewed from a forward direction of the vehicle, on a left or right side of a fuel tank of the vehicle and at a position partially overlapping with the fuel tank or at a position not overlapping with the fuel tank. The cooler cover includes a louver formed on at least one of a left side-surface and/or a right side-surface as viewed from the forward direction.

### CROSS REFERENCE TO RELATED APPLICATIONS

This application is entitled to and claims the benefit of Japanese Patent Application No. 2024-199534, filed on November 15, 2024, the disclosure of which including the specification, drawings and abstract is incorporated herein by reference in its entirety.

### TECHNICAL FIELD

The present disclosure relates to a fuel cooler.

### Background Art

In a vehicle on which a diesel engine is mounted, a fuel injection system using a common rail is widely adopted. In the fuel injection system, the remaining fuel that is not combusted is returned to a fuel tank.

The return fuel is at an extremely high temperature. Thus, in a diesel engine vehicle, an air-cooled fuel cooler is disposed on the underside of a vehicle body, and the return fuel is cooled by the fuel cooler and then returned to the fuel tank.

The fuel cooler is disposed on the underside of the vehicle, and it is thus necessary to protect the cooler body from flying stones and the like from the road. Therefore, the fuel cooler is generally provided with a cooler cover that surrounds the cooler body.

Surrounding the cooler body with the cooler cover reduces airflow to the cooler body, resulting in a problem where the fuel cooling efficiency of the cooler body is reduced.

In order to solve such a problem, for example, Patent Literature (hereinafter, referred to as PTL) 1 discloses a technique of forming a louver on the bottom surface of a cooler cover, and guiding outside air to a cooler body by the louver to improve the cooling efficiency of the cooler body (see paragraphs [0030] to [0032] of PTL 1).

### Citation List

### Patent Literature

PTL 1

Japanese Patent Application Laid-Open No. 2008-162334

### Summary of Invention

### Technical Problem

It is considered that, as in PTL 1, forming a louver on the cooler cover protects the cooler body from flying stones and the like and suppresses the decrease in the cooling performance of the cooler body. However, in consideration of the increase in temperature of return fuel caused by the recent increase in fuel injection pressure of diesel engines and the damage to the fuel system components caused by the increase in temperature, it is desired to further improve the cooling performance of the fuel cooler.

The present invention has been made in consideration of the above points, and provides a fuel cooler that can improve cooling performance while protecting a cooler body from flying stones and the like.

### Solution to Problem

An aspect of a fuel cooler of the present invention is a fuel cooler for a vehicle, the fuel cooler including: a cooler body; and a cooler cover that is provided to surround the cooler body, in which the fuel cooler is disposed, as viewed from a forward direction of the vehicle, on a left or right side of a fuel tank of the vehicle and at a position partially overlapping with the fuel tank or at a position not overlapping with the fuel tank, and the cooler cover includes a louver formed on at least one of a left side-surface and/or a right side-surface as viewed from the forward direction.

### Advantageous Effects of Invention

According to the present invention, it is possible to realize a fuel cooler that can improve cooling performance while protecting a cooler body from flying stones and the like.

### BRIEF DESCRIPTION OF DRAWINGS

FIG. 1 is a schematic plan view for describing a mounting position of a fuel cooler on a vehicle according to an embodiment;

FIG. 2 is a perspective view of the fuel cooler as viewed obliquely from the front;

FIG. 3 is a perspective view of the fuel cooler as viewed obliquely from the rear;

FIG. 4 is an exploded perspective view of the fuel cooler;

FIG. 5 is a diagram illustrating a state in which traveling air is drawn into a cooler cover by a louver;

FIG. 6 is a diagram for describing an opening amount of a blade;

FIG. 7 is a diagram illustrating a flying range of a flying stone or the like that is kicked up by a wheel when the vehicle moves backward; and

FIG. 8 is another diagram illustrating a flying range of a flying stone or the like that is kicked up by a wheel when the vehicle moves backward.

### DESCRIPTION OF EMBODIMENTS

Hereinafter, an embodiment of the present disclosure will be described with reference to the drawings.

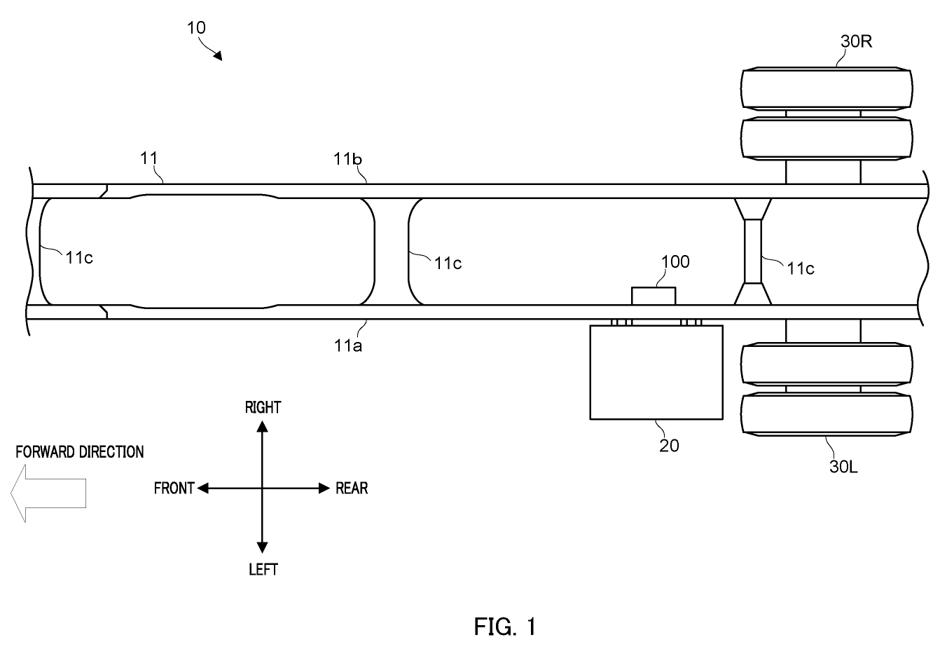

FIG. 1 is a schematic plan view for describing a mounting position of fuel cooler 100 on vehicle 10 according to an embodiment.

Vehicle 10 is a vehicle equipped with a diesel engine (not illustrated), and is, for example, a large vehicle such as a tractor.

Vehicle 10 includes chassis frame 11 composed of a pair of left and right side members 11a and 11b extending in the front-rear direction and a plurality of cross members 11c provided by being straddled between side members 11a and 11b. A superstructure (not illustrated) such as a cargo bed is provided on chassis frame 11.

Fuel tank 20 is fixed to side member 11a. Fuel tank 20 is disposed in front of left wheel 30L of pair of wheels 30L and 30R.

In addition, fuel cooler 100 is fixed to side member 11a. Fuel cooler 100 is disposed, as viewed from the forward direction of vehicle 10, on the left or right side of fuel tank 20 of vehicle 10 and at a position partially overlapping with fuel tank 20 or at a position not overlapping with fuel tank 20. Note that the forward direction is a front direction in the vehicle front-rear direction. In other words, fuel cooler 100 is disposed at a position that is at least partially shifted to a side from fuel tank 20 as viewed from the forward direction of vehicle 10. In the embodiment, fuel cooler 100 is disposed at a position not overlapping with fuel tank 20. In this manner, the amount of airflow hitting fuel cooler 100 increases, which is more preferred.

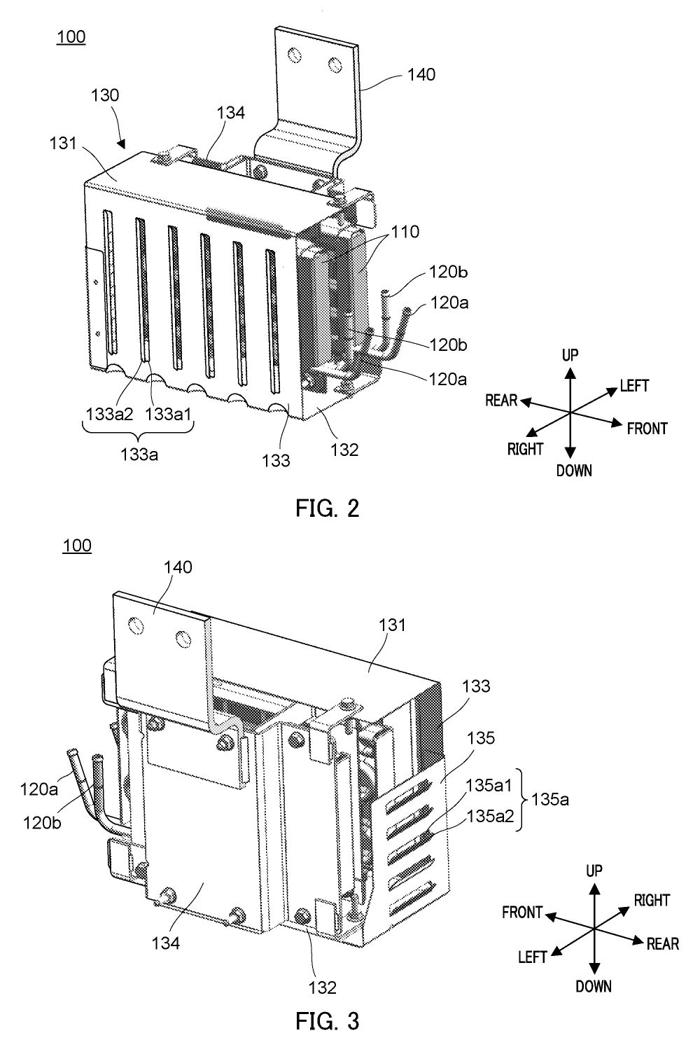

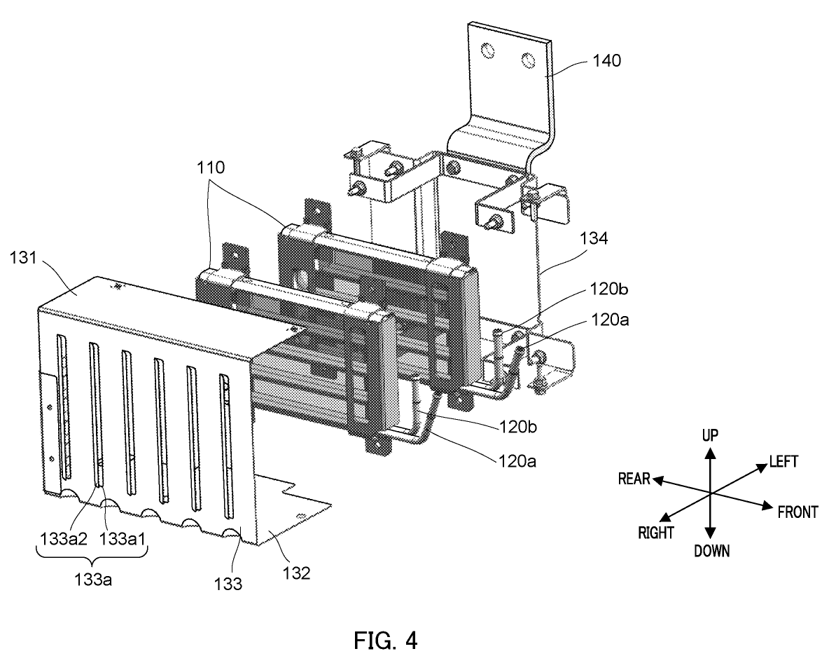

The configuration of fuel cooler 100 of the present embodiment will be described with reference to FIGS. 2 to 4. FIG. 2 is a perspective view of fuel cooler 100 as viewed obliquely from the front. FIG. 3 is a perspective view of fuel cooler 100 as viewed obliquely from the rear. FIG. 4 is an exploded perspective view of fuel cooler 100.

Fuel cooler 100 includes cooler body 110, connection pipes 120a and 120b, cooler cover 130, and connection section 140.

Cooler body 110 is composed of a pipe, a cooling fin provided around the pipe, and the like. In the example of the present embodiment, as can be seen from the drawings, cooler body 110 is composed of two cooling units, but the number of cooling units is not limited thereto, and may be one or three or more.

Fuel cooler 100 is connected to a return pipe (not illustrated) that returns return fuel of a diesel engine to fuel tank 20. Specifically, fuel cooler 100 is configured to introduce the return fuel from the diesel engine through connection pipe 120a and to discharge the cooled return fuel to fuel tank 20 through connection pipe 120b.

Cooler cover 130 is, for example, a metal plate and is composed of top plate 131, bottom plate 132, right-side plate 133, left-side plate 134, and back plate 135. In the example of the present embodiment, the front surface of cooler cover 130 is open. Cooler body 110 is fixed inside cooler cover 130.

Top plate 131, bottom plate 132, and left-side plate 134 are metal plates in which an opening is not formed. Connection section 140 is coupled to left-side plate 134. Cooler cover 130 is connected to side member 11a via connection section 140. As a result, fuel cooler 110 is fixed at a position on the right side of fuel tank 20.

Louver 133a is formed on right-side plate 133. Louver 133a is composed of opening 133a1 formed in right-side plate 133 and blade 133a2 that guides the wind to opening 133a1. Opening 133a1 is formed across right-side plate 133 in the up-down direction and has a vertically long shape. Blade 133a2 includes a base at a rear end portion of opening 133a1 and is open such that a tip is separated from right-side plate 133 as the tip proceeds forward. In other words, blade 133a2 protrudes obliquely toward the forward direction from the main surface of a plate (in the example of the embodiment, right-side plate 133) on which louver 133a is formed.

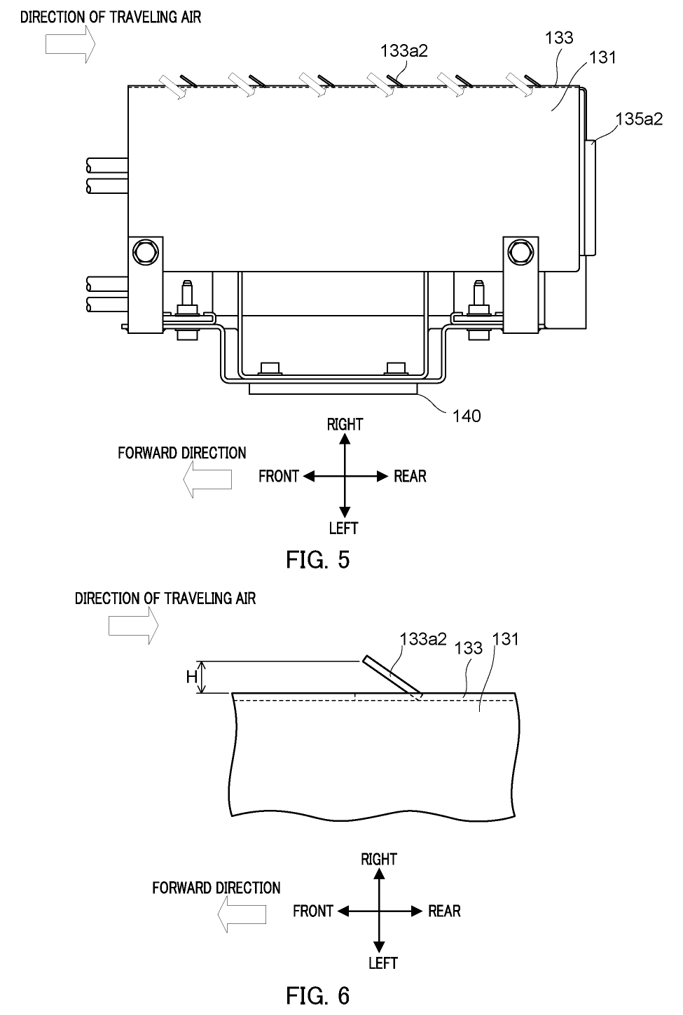

This allows the traveling air flowing along the side of cooler cover 130 to be drawn into cooler cover 130 by louver 133a, as illustrated in FIG. 5.

In the example of the present embodiment, louver 133a is formed by cutting three sides of the portion corresponding to opening 133a1 in right-side plate 133, and then bending the tip of blade 133a2 rearward. Thus, the width of the short side of opening 133a1 and the width of the short side of blade 133a2 are the same. The width of the short side is set such that a flying stone or the like from the road having a size capable of damaging cooler body 110 does not enter cooler cover 130 from opening 133a1, considering the size of the flying stone or the like from the road.

In the present embodiment, opening amount H of blade 133a2 from the main surface of right-side plate 133 illustrated in FIG. 6 is in a range of less than 5 mm. This prevents flying stones and the like from the road that are large enough to damage cooler body 110 from entering cooler cover 130 through opening 133a1, while efficiently guiding the traveling air into cooler cover 130. Incidentally, according to the experiment, the size of the chipping (debris) from the road ranges from 5 to 13 mm, and thus entry of the chipping through louver 133a can be prevented by setting opening amount H to less than 5 mm.

In the example of the present embodiment, six louvers 133a are formed. However, the number, the disposition, and the shape of louvers 133a are not limited to the example of the present embodiment as long as the traveling air can be efficiently applied to cooler body 110.

In addition, in the present embodiment, louver 135a is formed on back plate 135. Louver 135a is composed of opening 135a1 formed in back plate 135 and blade 135a2. Opening 135a1 is formed across back plate 135 in the left-right direction and has a horizontally long shape. Blade 135a2 includes a base at a lower end portion of opening 135a1 and is open such that a tip is separated from back plate 135 as the tip proceeds upward. In other words, blade 135a2 protrudes obliquely toward the upward direction from the main surface of a plate (in the example of the embodiment, back plate 135) on which louver 135a is formed.

In the example of the present embodiment, louver 135a is formed by cutting three sides of the portion corresponding to opening 135a1 in back plate 135, and then bending the tip of blade 135a2 downward. Thus, the width of the short side of opening 135a1 and the width of the short side of blade 135a2 are the same. The width of the short side is such that a flying stone or the like from the road having a size that damages cooler body 110 does not enter cooler cover 130 from opening 135a1, considering the size of the flying stone or the like from the road.

In fuel cooler 100, louver 133a is formed on right-side plate 133, so that the traveling air applied to cooler body 110 can be increased to increase the cooling efficiency of cooler body 110 while preventing cooler body 110 from being damaged.

Furthermore, in fuel cooler 100, louver 135a is formed on back plate 135, so that cooler body 110 can be protected from the flying stones and the like from rear wheels 30L and 30R when vehicle 10 moves backward, and the decrease in the cooling efficiency of cooler body 110 when vehicle 10 moves forward can be suppressed. That is, in a case where louver 135a is not formed on back plate 135, cooler body 110 can be protected from the flying stones and the like from rear wheels 30L and 30R when vehicle 10 moves backward, but the traveling air from the front is not discharged to the rear when vehicle 10 moves forward, which decreases the cooling efficiency of cooler body 110. In consideration of this, in the present embodiment, louver 135a is formed on back plate 135.

As can be seen from FIG. 3, the upper end of back plate 135 does not reach top plate 131, and thus the upper portion of the rear surface of cooler cover 130 is largely open. Thus, more traveling air from the front escapes rearward when vehicle 10 moves forward, thereby improving the cooling efficiency of cooler body 110.

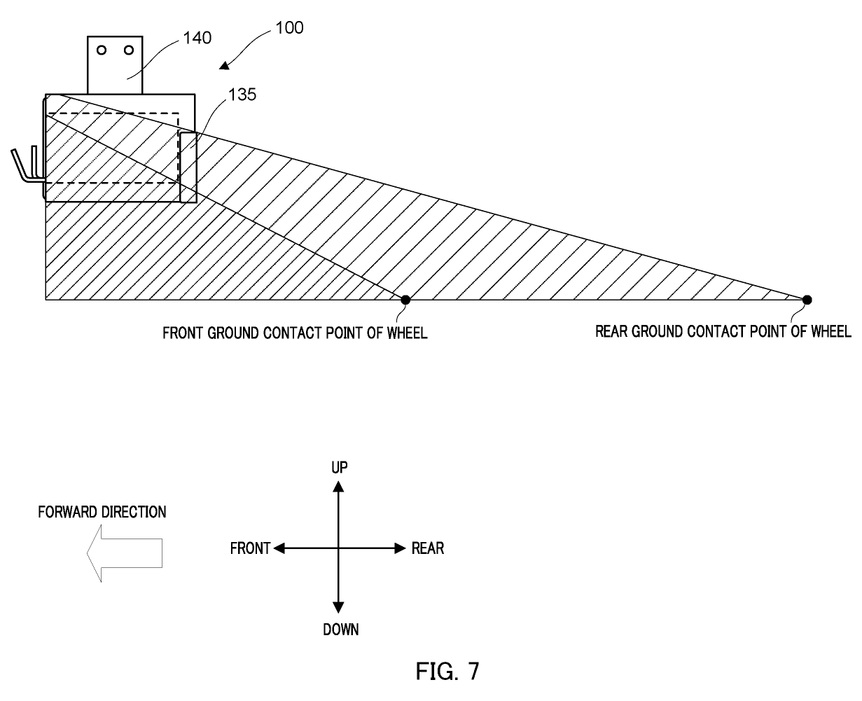

Here, as illustrated in FIG. 7, the height of back plate 135 is preferred to be set in consideration of the flying range (indicated by oblique lines in the drawing) of the flying stone or the like that is kicked up by wheel 30L when vehicle 10 moves backward, for example. That is, the height of back plate 135 on which louver 135a is formed may be selected based on the positional relationship between wheels 30L and 30R and fuel cooler 100.

As described above, according to the present embodiment, fuel cooler 100 includes cooler body 110 and cooler cover 130 that is provided to surround cooler body 110. Fuel cooler 100 is disposed, as viewed from the forward direction of vehicle 10, on a left or right side of fuel tank 20 of vehicle 10 and at a position partially overlapping with fuel tank 20 or at a position not overlapping with fuel tank 20 (in the embodiment, a position shifted to the right side of fuel tank 20), and cooler cover 130 includes louver 133a formed on at least one of a left side-surface and/or a right side-surface as viewed from the forward direction.

Accordingly, it is possible to realize fuel cooler 100 that can improve cooling performance while protecting cooler body 110 from flying stones and the like.

In addition, according to the present embodiment, fuel cooler 100 is disposed on the front side in the forward direction with respect to wheels 30L and 30R closest to fuel cooler 100 among wheels 30 of vehicle 10, and cooler cover 130 includes louver 135a formed on the rear surface as viewed from the forward direction. Note that the rear surface refers to a surface on the rear side in the vehicle front-rear direction.

Thus, when vehicle 10 moves forward, fuel cooler 100 is hardly affected by flying stones and the like from wheels 30L and 30R closest to fuel cooler 100 because fuel cooler 100 is positioned on the front side with respect to wheels 30L and 30R closest to fuel cooler 100, and thus the front surface of cooler cover 130 can be open. As a result, the amount of the traveling air applied to cooler body 110 can be increased.

Meanwhile, fuel cooler 100 is positioned on the rear side of wheels 30L and 30R closest to fuel cooler 100 when vehicle 10 moves backward, and thus fuel cooler 100 is affected by the flying stones and the like from wheels 30L and 30R closest to fuel cooler 100. However, the flying stones and the like from wheels 30L and 30R do not reach cooler body 110 because back plate 135 on which louver 135a is formed is provided. Therefore, even in the case of moving backward, it is possible to improve cooling performance while protecting cooler body 110 from the flying stones and the like.

The above-described embodiment is merely an example of specific embodiment of the present invention, and the technical scope of the present invention should not be construed as being limited thereto. That is, the present invention can be implemented in various forms without departing from the spirit or main features thereof.

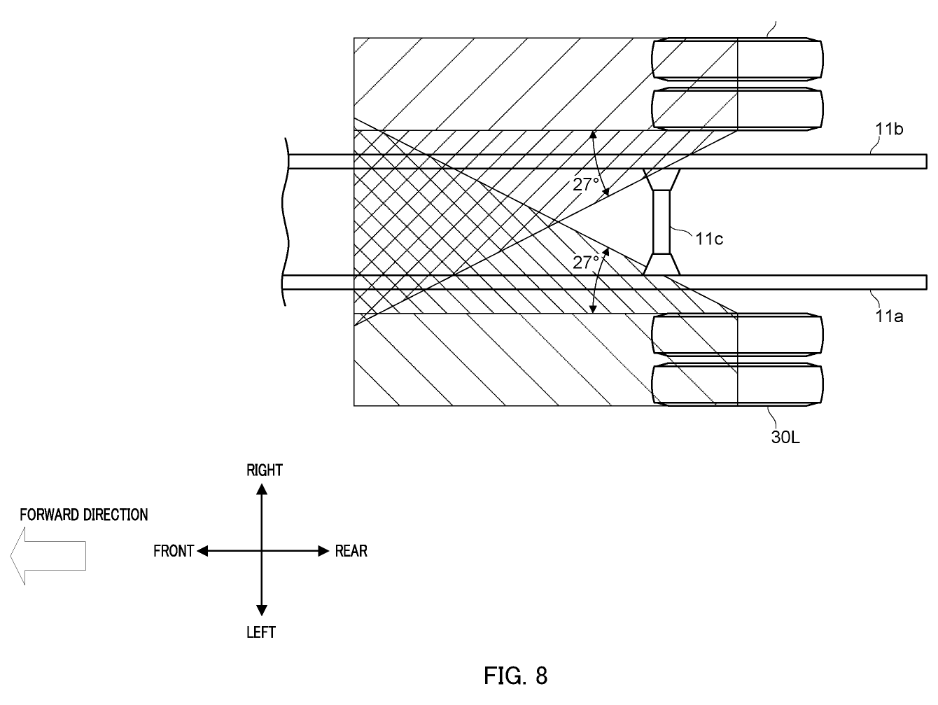

FIG. 8 is a schematic plan view showing a flying range (indicated by oblique lines in the drawing) of the flying stone or the like that is kicked up by wheels 30L and 30R when vehicle 10 moves backward. By placing fuel cooler 100 outside the area indicated by oblique lines in the drawing, it is possible to avoid the influence of flying stones and the like when vehicle 10 moves backward, and back plate 135 can be omitted.

### Industrial Applicability

The present disclosure is useful for, for example, a fuel cooler that cools return fuel to a fuel tank of a diesel engine.

### Reference Signs List

10 Vehicle

11 Chassis frame

11a, 11b Side member

11c Cross member

20 Fuel tank

30L, 30R Wheel

100 Fuel cooler

110 Cooler body

120a, 120b Connection pipe

130 Cooler cover

131 Top plate

132 Bottom plate

133 Right-side plate

133a1, 135a1 Opening

133a2, 135a2 Blade

134 Left-side plate

135 Back plate

140 Connection section

1. A fuel cooler for a vehicle, the fuel cooler comprising:
a cooler body; and
a cooler cover that is provided to surround the cooler body, wherein
the fuel cooler is disposed, as viewed from a forward direction of the vehicle, on a left or right side of a fuel tank of the vehicle and at a position partially overlapping with the fuel tank or at a position not overlapping with the fuel tank, and
the cooler cover includes a louver formed on at least one of a left side-surface and/or a right side-surface as viewed from the forward direction.

2. The fuel cooler according to claim 1, wherein the fuel cooler is disposed on a front side in the forward direction with respect to a wheel closest to the fuel cooler among wheels of the vehicle, and the cooler cover includes a louver formed on a rear surface.

3. The fuel cooler according to claim 2, wherein the cooler cover includes, as viewed from the forward direction:
a front surface that is open; and the rear surface including a portion on which the louver is formed and an opening portion.

4. The fuel cooler according to claim 3, wherein a height of the portion on which the louver is formed is selected based on a positional relationship between the wheel and the fuel cooler.

5. The fuel cooler according to claim 1, wherein a blade of the louver protrudes obliquely toward the forward direction from a main surface of a plate on which the louver is formed.
